(19) United States
(12) Patent Application Publication
(10) Pub. No.: US 2011/0022441 A1
(43) Pub. Date: Jan. 27, 2011

(54) SCHEDULING APPARATUS AND METHOD

(76) Inventors: Gavin Robertson, Glasgow (GB); Alison Murray, Glasgow (GB)

Correspondence Address: BUTZEL LONG;IP DOCKETING DEPT, 350 SOUTH MAIN STREET, SUITE 300, ANN ARBOR, MI, 48104, US

(21) Appl. No.: 12/812,658

(22) PCT Filed: Jan. 29, 2009
(86) PCT No.: PCT/GB2009/050083

§ 371 Date: Oct. 11, 2010

Related U.S. Application Data
(60) Provisional application No. 61/032,597, filed on Feb. 29, 2008.

(51) Int. Cl. G06Q 10/00; G01C 21/00

(52) U.S. Cl. 705/9; 701/202

(57) ABSTRACT

A scheduling method comprising: compiling non-location specific transport data comprising a plurality of travel options; receiving a user s intended appointment location; identifying the user's location; determining a local time based upon the user's location; determining a suitable travel option specific to the user's location, local time, and the intended appointment location; and communicating the suitable travel option to the user.

### BACKGROUND OF THE INVENTION

The present invention relates to an apparatus and method to assist with the scheduling of journeys and/or appointments. In particular, the invention relates to an apparatus adapted to determine journey and/or appointment data based upon a user's location and local time.

Various sources of travel information exist, usually in the form of timetable data. These include websites provided by a travel operator or comparison websites which provide information obtained from a number of travel operators. Often, online booking is possible where the entire booking procedure is automated. Departure and arrival times for the selected journey are typically provided in the local time. However, beyond this, it is for the user to decide which of the travel options to select. It can be a complex matter to, say, arrive within a short time period before an appointment, especially in cases where split journeys involving a number of different modes of transport. A lack of local knowledge may add to the complexity: the distance from the transport terminus to the appointment location, local traffic conditions, local transport availability, walking short-cuts and so on may all be unknown. There are no known sources of travel information which even present all of local, national and international travel options, never mind connecting, organizing and cross referencing these travel options.

Various forms of diaries or schedules are also known. These include computerised schedules which automatically open at a current time window (such as the present day, week or month). Such schedules can perform a range of other functions including providing automated prompts of imminent appointments or the arrangement of an appointment via an email invitation. However, they do not assist the user to calculate a suitable appointment time (other than by showing any conflict with another appointment). In particular, there is no facility for determining travel information based on an intended appointment location and time. Furthermore, the current time window of the computerised schedule, and the prompts, are determined from the user's computer. This typically does not automatically update as the user moves to a different location having a different local time.

Navigation aids such as GPS navigation systems or online maps are also known. These assist the user to navigate from one location to another by providing step by step journey instructions. They do not assist the user for scheduling appointments other than providing a total journey time, typically involving a single means of transport such as a car journey by the user. They do not utilize data relating to other means of transport such as air flight data.

### SUMMARY OF THE INVENTION

According to a first aspect of the present invention there is provided a scheduling method comprising:
compiling non-location specific transport data comprising a plurality of travel options;
receiving a user's intended appointment location;
identifying the user's location;
determining a local time based upon the user's location;
determining a suitable travel option specific to the user's location, local time, and the intended appointment location; and
communicating the suitable travel option to the user.

The term “non-location specific transport data” is intended to mean that transport data is compiled which relates to a plurality of locations. A suitable travel option which is specific to the user's location is derived from this data.

The method may include receiving the user's intended appointment time. The method may include determining a suitable travel option specific to the user's location, local time, and the intended appointment location and the user's intended appointment time.

The user's intended appointment location may be determined or derived from a timetable. The timetable may comprise a transport timetable. Alternatively or in addition, the timetable may comprise a diary or an academic timetable or a room booking timetable or the like.

The suitable travel option communicated to the user may comprise one or more of a mode of transport, and a location and time for departure. However, the suitable travel option may merely be a suggestion such as which mode of transport to take. The travel option may comprise a plurality of modes of transport. A plurality of suitable travel options may be communicated to the user. One or more of the suggested order and route may be communicated to the user.

The non-location specific transport data may comprise data obtained from a plurality of transport operators. Alternatively or in addition, the non-location specific transport data may comprise further information such as local taxi companies and their contact information. Alternatively or in addition, the non-location specific transport data may comprise road mapping data.

Alternatively or in addition, the non-location specific transport data may comprise data obtained from at least one user. The data obtained from a user may or may not include specific travel information such as arrival/departure times. The method may include rewarding a user for contributing the non-location specific transport data. The method may include penalising a user for contributing inaccurate non-location specific transport data.

The method may include connecting to a user network to allow a user to receive travel assistance or suggestions.

The non-location specific transport data may relate to a plurality of modes of transport. The suitable travel option may involve a plurality of modes of transport. The non-location specific transport data may relate to a plurality of types of transport data, such as local, national and international transport data. The method may include connecting or cross referencing at least two of these types of transport data.

The method may include updating the determined suitable travel option on a regular basis. The suitable travel option may change as travel options expire.

The method may include determining a time window and communicating the suitable travel option to the user only while it is within the determined time window. The end time of the time window may be determined based upon the user's intended appointment location and time. Alternatively, future travel options may also be communicated to the user.

The method may include communicating a suggested appointment time based upon the user's location, local time and transport data. The method may include identifying a plurality of user's locations and communicating a suggested appointment time based upon the plurality of users' locations, local time and transport data.

The method may include prompting the user when the suitable travel option becomes imminent.

The user's location may be identified using at least one of a user inputted address, GPS location and map reference. The method may include displaying the user's location on a map. The method may include displaying the user's route on a map.

The method may include providing a user interface. The user interface may be one or more of text, voice, short-cut keystrokes or automated input from location-based system.

The method may include using a default appointment time in the absence of a user specified appointment time. The default appointment time may be the earliest that the transport data allows.

The method may include receiving travel status data and determining a suitable travel option also based upon the received travel status. The suitable travel option may be updated as travel status data is received. The received travel status data may comprise at least one of traffic congestion data, road closures and train or flight delays and cancellations.

The method may include compiling event data and communicating the event data to the user based upon at least the user's location. The method may include compiling marketing data and communicating the marketing data to the user based upon at least the user's location.

The method may include compiling at least one user specific location such as a home or work address. The method may include compiling at least one user specific preference such as a preferred route, pricing, mode of transport or travel operator. The method may include determining the suitable travel option also based upon the user specific preference.

The method may include compiling user specific interests which are selected by the user. The method may include communicating at least one of the event and marketing data to the user based upon the user's selected interests. The user's selected interests may be specific to the user's lifestyle or career.

The method may include allowing a user to compile a personal schedule or timetable. The personal schedule may include one or more favourite locations, routes or times to travel. The method may include determining a suitable travel option using or taking account of this personal schedule. The method may include allowing a user to customise an externally provided timetable.

According to a second aspect of the present invention there is provided a scheduling apparatus comprising:
a database adapted to store non-location specific transport data comprising a plurality of travel options;
inputting means for receiving a user's location and intended appointment location;
processing means for determining a local time based upon the user's location, and determining a suitable travel option specific to the user's location, local time, and the intended appointment location; and
means for communicating the suitable travel option to the user.

The inputting means may also be adapted for receiving the user's intended appointment time. The processing means may be adapted for determining a suitable travel option specific to the user's location, local time, and the intended appointment location and the intended appointment time.

The scheduling apparatus may be provided by a computer via a website. The database may be provided by a computer memory system of the computer. The processing means may comprise the computer's processor.

The inputting means may be a device comprising at least one of a PC, laptop or mobile device which is accessing the website. The means for communicating the suitable travel option to the user may comprise the internet connection hardware and software for downloading data to the device.

### BRIEF DESCRIPTION OF THE DRAWING

Embodiments of the present invention will now be described, by way of example only, with reference to the accompanying drawings in which:

FIG. 1 is a schematic diagram of the scheduling apparatus.

### DESCRIPTION OF THE PREFERRED EMBODIMENT

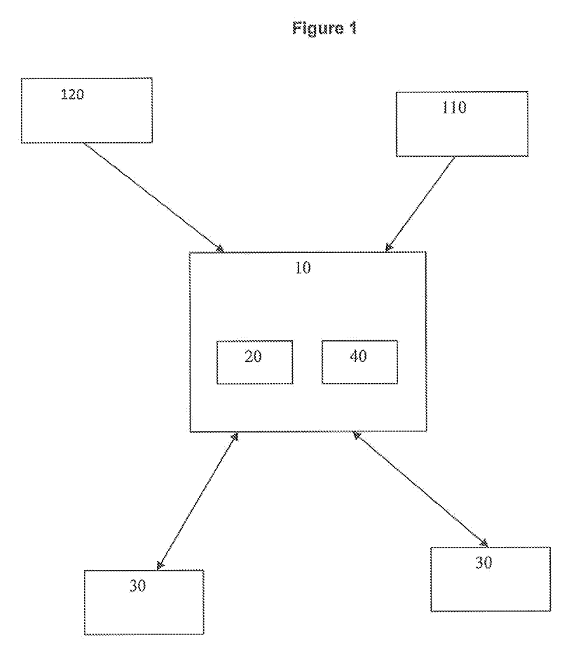

FIG. 1 shows a scheduling apparatus comprising a computer 10 configured to operate as a website provider and which is connected to the internet. Within the memory system 20 of the computer 10 is stored a database of non-location specific transport data comprising a plurality of travel options.

This master timetable of transport data has been obtained from a number of sources including travel operators for various modes of transport such as airlines, ship and ferry operators, and bus operators. The timetable includes arrival and departure dates and times, identifiers (such as flight codes) and pricing information. In addition, the transport data includes road mapping data as found in known satellite navigation systems.

However, it is possible to retrieve transport data to be compiled in the master timetable as and when it is required by a user. Another possibility is to create a ‘virtual’ master timetable. In such case, the transport data is remotely accessed when required but never downloaded and stored on the computer 10.

In addition, some of the transport data has been obtained from users of the system. Such users often have substantial local knowledge which national or international travel operators lack. Furthermore, the contribution by users can substantially reduce the complexity and cost of obtaining the large amount of data involved. The data obtained from users need not include specific travel information such as arrival/departure times. Rather, it could just be a journey suggestion or notes from a user's experience of that journey.

Also, the computer 10 can connect to a user network using a communication system or protocol such as instant messaging or Twitter to allow the user to receive travel assistance or suggestions from other users.

The method can include rewarding a user for contributing the non-location specific transport data. This could be financial or by public recognition or by other means. A financial reward could comprise a share of advertising revenue received from advertisers paying to promote products or services on the website. The method can also include penalising a user for contributing inaccurate non-location specific transport data. This could be financial or by banning or limiting resources to the user or by other means. A rating system can be used which allows users to rate the data provided by another user or the apparatus may rate automatically according to parameters such as user experience or data accuracy.

A user can access the website using inputting means 30 which may be a PC, laptop or mobile telephone. The user can input the user's location and also an intended appointment location and time. The term “appointment” is to be understood broadly such that it can include a casual meeting with friends or to return to the user's home. A default appointment time is used in the case where the user does not specify an appointment time. In such case, the default appointment time is taken to be as soon as possible.

The computer 10 also includes a processor 40 which provides the processing means. This determines a local time based upon the user's location. For instance, if the time is 18:00 GMT, then the local time for a user in Detroit would be 13:00.

Using an algorithm implemented by a computer program running on the computer 10, the processor 40 correlates the transport data, local time and intended appointment location and time and determines a suitable travel option based upon these factors. The travel option is suitable in the sense that, in the absence of any other predetermined criteria, the travel option provides the means of arriving at the appointment closest to the stated appointment time.

The algorithm for achieving this is not complex. It simply requires using arrival and departure time as numerical values, allowing for time differences, and determining the travel option from the transport data using known searching and indexing procedures which will achieve arriving at the appointment close to the stated appointment time (another numerical value).

The suitable travel option may also meet predetermined criteria such as satisfactory departure times, the least number of modes of transport, pricing considerations and so on. Some or more of these can be specified by the user. Weightings can be used within the algorithm in a known manner to allow for these predetermined criteria.

A margin of error is included in the algorithm. This margin of error can vary depending on factors such as the mode (and number of modes) of transport, the distance traveled and so on. For an appointment in the same country and involving a single mode of transport, the margin of error can be small such as 15 minutes. For an appointment in a different country and involving more than one mode of transport, the margin of error can be greater such as two hours.

However, a detailed travel option need not be communicated to the user. It would still be beneficial if simply the best mode of transport, or a skeleton route, was provided to the user. The computer 10 can be adapted to allow the user to build upon the communicated best mode of transport or a skeleton route to create a new timetable.

The suitable travel option is communicated to the user such as via the internet. For other devices, such as mobile phones, the suitable travel option could be communicated by email or text message. If a number of options exist which are each suitable for travel within the allowable time, all of these options can be communicated to the user.

The computer 10 determines a time window for which the determined suitable travel option remains valid and the suitable travel option is only communicated to the user only while it is within the determined time window.

The computer 10 is configured to update the determined suitable travel option on a regular basis. This can be in real time to the user's mobile device or whenever the user accesses the website using a PC. Therefore, the suitable travel option will change as travel options expire. A new time window, for the updated travel option, will also be generated. Automated prompts can be communicated to the user when the suitable travel option becomes imminent.

The computer 10 is also configured to, at the user's request, determine and communicate a suggested alternative appointment time based upon user's location, local time and transport data. This option is presented when no suitable travel options exist for the user's specified appointment time.

The appointment may involve a number of different attendees travelling from different locations. Another option provided is that the algorithm can be implemented for each of these attendees so as to suggest an appointment time which is suitable for all attendees. This is simply performed by determining the latest date and time from the travel data for each of the attendees.

The user's location can be identified using a user inputted address, GPS location or map reference. Each of these can be offered as alternatives to the user. An alternative approach is to analyse the IP address of the user's computer using geolocation software to determine the user's location. The computer 10 can display the user's location and route on a map. If the computer 10 is transportable (such as a laptop or mobile phone), the user can view his location and route while taking the journey. The computer 10 allows the user to make notes which can be assigned to specific points of the journey. These notes may be assigned as public, such that they can be displayed to other users, or private.

The computer 10 is also adapted to receive travel status data 110 such as local weather conditions, traffic congestion data, road closures and flight delays or cancellations. This data is included as a weighting in the algorithm (a flight cancellation for instance would be sufficient to eliminate the respective flight from the possible options while traffic delays may only make the respective travel option less desirable).

The user can also specify and give details of certain locations such as a home or work addresses. This information is stored specific to the user to avoid repeatedly having to enter these details. The user can also specify preferences such as a preferred route, price levels, modes of transport or particular travel operators. These factors will be given appropriate weightings when determining the suitable travel option.

The computer 10 is also adapted to receive event data and marketing data 120 from third parties. The event data relates to the likes of conferences, exhibitions, festivals or sporting events that is to be held in a particular location. The marketing data comprises details of products or services being offered in a particular location. The computer 10 filters the event and marketing data so that only data relating to the user's location and/or intended location is communicated to the user. The user may be allowed some or full control of which type of data is communicated.

The user can specify certain interests relating to the likes of the user's lifestyle or career. These could be favourite music, sporting teams or the like. In such case, the computer 10 further filters the event and marketing data so that only data relating to the user's interests is communicated.

A location/destination could be pre-loaded and used as a commercial tool to link to the computer 10 to find out how to get to that destination. For example, a music band could link from their web-site to the computer 10 to allow their gig location to be entered in as a destination and thus start the search process of how to get there.

The website is configured to require a user identifier such as a user name and password before access is granted. The website is further configured to provide a user specific presentation based on the user and the user's preferences and interests.

Whilst specific embodiments of the present invention have been described above, it will be appreciated that departures from the described embodiments may still fall within the scope of the present invention.

1. A scheduling method comprising:
compiling non-location specific transport data comprising a plurality of travel options;
receiving a user's intended appointment location;
identifying the user's location;
determining a local time based upon the user's location;
determining a suitable travel option specific to the user's location, local time, and the intended appointment location; and
communicating the suitable travel option to the user.

2. A method as claimed in claim 1, including receiving the user's intended appointment time and determining a suitable travel option specific to the user's location, local time, and the intended appointment location and the user's intended appointment time.

3. A method as claimed in claim 1, wherein the user's intended appointment location is determined or derived from a timetable.

4. A method as claimed in claim 1, wherein the suitable travel option communicated to the user comprises one or more of a mode of transport, and a location and time for departure.

5. A method as claimed in claim 1, wherein a plurality of suitable travel options are communicated to the user.

6. A method as claimed in claim 1, wherein the non-location specific transport data comprises local information.

7. A method as claimed in claim 1, wherein the non-location specific transport data comprises road mapping data.

8. A method as claimed in claim 1, wherein the non-location specific transport data comprises data obtained from at least one user.

9. A method as claimed in claim 1, including connecting to a user network to allow a user to receive travel assistance or suggestions.

10. A method as claimed in claim 1, wherein the suitable travel option involves a plurality of modes of transport.

11. A method as claimed in claim 1, wherein the non-location specific transport data relates to a plurality of types of transport data, and the method includes connecting or cross referencing at least two of these types of transport data.

12. A method as claimed in claim 1, including determining a time window and communicating the suitable travel option to the user while it is within the determined time window.

13. A method as claimed in claim 1, including communicating a suggested appointment time based upon the user's location, local time and transport data.

14. A method as claimed in claim 1, including identifying a plurality of user's locations and communicating a suggested appointment time based upon the plurality of users' locations, local time and transport data.

15. A method as claimed in claim 1, wherein the user's location is identified using at least one of a user inputted address, GPS location and map reference.

16. A method as claimed in claim 1, including displaying one or both of the user's location and route on a map.

17. A method as claimed in claim 1, including receiving travel status data and determining a suitable travel option also based upon the received travel status.

18. A method as claimed in claim 1, including compiling event or marketing data and communicating the event data to the user based upon at least the user's location.

19. A method as claimed in claim 1, including compiling at least one user specific location or preference.

20. A method as claimed in claim 18, including compiling user specific interests which are selected by the user and communicating at least one of the event and marketing data to the user based upon the user's selected interests.

21. A method as claimed in claim 1, including allowing a user to compile a personal schedule or timetable.

22. A method as claimed in claim 21, wherein the personal schedule includes one or more favourite locations, routes or times to travel, and the method includes determining a suitable travel option using or taking account of this personal schedule.

23. A method as claimed in claim 1, including allowing a user to customise an externally provided timetable.

24. A scheduling apparatus comprising:
a database adapted to store non-location specific transport data comprising a plurality of travel options;
inputting means for receiving a user's location and intended appointment location;
processing means for determining a local time based upon the user's location, and determining a suitable travel option specific to the user's location, local time, and the intended appointment location; and
means for communicating the suitable travel option to the user.

25. A scheduling apparatus as claimed in claim 24, wherein the inputting means is adapted to receive the user's intended appointment time, and the processing means is adapted to determine a suitable travel option specific to the user's location, local time, and the intended appointment location and the intended appointment time.

26. A scheduling apparatus as claimed in claim 24, wherein the scheduling apparatus is provided by a computer via a website.

27. A scheduling apparatus as claimed in claim 26, wherein the database is provided by a computer memory system of the computer and the processing means comprises the computer's processor.

28. A scheduling apparatus as claimed in claim 24, wherein the inputting means is a device comprising at least one of a PC, laptop or mobile device which can access the website.
